(19) United States
(12) Patent Application Publication
(10) Pub. No.: US 2015/0102526 A1
(43) Pub. Date: Apr. 16, 2015

(54) FABRIC FORMED BY THREE-DIMENSIONAL PRINTING PROCESS

(71) Applicant: Huyck Licensco, Inc., Youngsville, NC (US)

(72) Inventors: Kevin Ward, Coldbrook (CA); Oliver Baumann, Gomaringen (DE)

(21) Appl. No.: 14/498,289

(22) Filed: Sep. 26, 2014

Related U.S. Application Data
(60) Provisional application No. 61/891,716, filed on Oct. 16, 2013.

(51) Int. Cl. B29C 67/00

(52) U.S. Cl. CPC B29C 67/0059; B29C 67/0092; B29C 67/0088; B29K 2101/12
USPC 264/308

(57) ABSTRACT

The present invention is directed generally to fabrics, and more specifically to fabrics and belts employed in industrial processes.

### RELATED APPLICATION

The present invention claims the benefit of and priority from U.S. Provisional Patent Application No. 61/891,716, filed on Oct. 16, 2013, the disclosure of which is hereby incorporated herein in its entirety.

### FIELD OF THE INVENTION

The present invention is directed generally to fabrics, and more specifically to fabrics and belts employed in industrial processes.

### BACKGROUND OF THE INVENTION

In the conventional fourdrinier papermaking process, a water slurry, or suspension, of cellulosic fibers (known as the paper “stock”) is fed onto the top of the upper run of an endless belt of woven wire and/or synthetic material that travels between two or more rolls. The belt, often referred to as a “forming fabric,” provides a papermaking surface on the upper surface of its upper run that operates as a filter to separate the cellulosic fibers of the paper stock from the aqueous medium, thereby forming a wet paper web. The aqueous medium drains through mesh openings of the forming fabric, known as drainage holes, by gravity or vacuum located on the lower surface of the upper run (i.e., the “machine side”) of the fabric.

After leaving the forming section, the paper web is transferred to a press section of the paper machine, where it is passed through the nips of one or more pairs of pressure rollers covered with another fabric, typically referred to as a “press felt.” Pressure from the rollers removes additional moisture from the web; the moisture removal is enhanced by the presence of a “batt” layer of the press felt. The paper is then transferred to a dryer section for further moisture removal. After drying, the paper is ready for secondary processing and packaging.

As used herein, the terms machine direction (“MD”) and cross machine direction (“CMD”) refer, respectively, to a direction aligned with the direction of travel of the papermakers' fabric on the papermaking machine, and a direction parallel to the fabric surface and traverse to the direction of travel. Likewise, directional references to the vertical relationship of the yarns in the fabric (e.g., above, below, top, bottom, beneath, etc.) assume that the papermaking surface of the fabric is the top of the fabric and the machine side surface of the fabric is the bottom of the fabric.

Typically, papermaker's fabrics are flat woven by a flat weaving process, with their ends being joined to form an endless belt by any one of a number of well-known joining methods, such as dismantling and reweaving the ends together (commonly known as splicing), or sewing on a pin-seamable flap or a special foldback on each end, then reweaving these into pin-seamable loops. In a flat woven papermaker's fabric, the warp yarns extend in the machine direction and the filling yarns extend in the cross machine direction.

Effective sheet and fiber support are important considerations in papermaking, especially for the forming section of the papermaking machine, where the wet web is initially formed. Additionally, the forming fabrics should exhibit good stability when they are run at high speeds on the papermaking machines, and preferably are highly permeable to reduce the amount of water retained in the web when it is transferred to the press section of the paper machine. In both tissue and fine paper applications (i.e., paper for use in quality printing, carbonizing, cigarettes, electrical condensers, and like) the papermaking surface comprises a very finely woven or fine wire mesh structure.

Typically, finely woven fabrics such as those used in fine paper and tissue applications include at least some relatively small diameter machine direction or cross machine direction yarns. However, such yarns tend to be delicate, leading to a short surface life for the fabric. Moreover, the use of smaller yarns can also adversely affect the mechanical stability of the fabric (especially in terms of skew resistance, narrowing propensity and stiffness), which may negatively impact both the service life and the performance of the fabric.

To combat these problems associated with fine weave fabrics, multi-layer forming fabrics have been developed with fine-mesh yarns on the paper forming surface to facilitate paper formation and coarser-mesh yarns on the machine contact side to provide strength and durability. For example, fabrics have been constructed which employ one set of machine direction yarns which interweave with two sets of cross machine direction yarns to form a fabric having a fine paper forming surface and a more durable machine side surface. These fabrics form part of a class of fabrics which are generally referred to as “double layer” fabrics. Similarly, fabrics have been constructed which include two sets of machine direction yarns and two sets of cross machine direction yarns that form a fine mesh paper side fabric layer and a separate, coarser machine side fabric layer. In these fabrics, which are part of a class of fabrics generally referred to as “triple layer” fabrics, the two fabric layers are typically bound together by separate stitching yarns. However, they may also be bound together using yarns from one or more of the sets of bottom and top cross machine direction and machine direction yarns. As double and triple layer fabrics include additional sets of yarn as compared to single layer fabrics, these fabrics typically have a higher “caliper” (i.e., they are thicker) than comparable single layer fabrics. An illustrative double layer fabric is shown in U.S. Pat. No. 4,423,755 to Thompson, and illustrative triple layer fabrics are shown in U.S. Pat. No. 4,501,303 to Osterberg, U.S. Pat. No. 5,152,326 to Vohringer, U.S. Pat. Nos. 5,437,315 and 5,967,195 to Ward, and U.S. Pat. No. 6,745,797 to Troughton.

### BRIEF DESCRIPTION OF THE FIGURES

FIGS. 1 and 2 are, respectively, schematic top and bottom views of a woven triple layer forming fabric.

FIG. 3 is a section view of the forming fabric of FIGS. 1 and 2 taken along line 3-3 of FIG. 1.

FIG. 4 is a top view of a forming fabric formed by three-dimensional printing techniques.

FIG. 5 is a bottom view of the forming fabric of FIG. 4.

FIG. 6 is a section view of the forming fabric of FIG. 4 taken in the machine direction.

FIG. 7 is a top view of another forming fabric formed by three-dimensional printing techniques.

FIG. 8 is a bottom view of the forming fabric of FIG. 7.

FIG. 9 is a section view of the forming fabric of FIG. 7 taken in the machine direction.

### DETAILED DESCRIPTION OF EMBODIMENTS OF THE INVENTION

The present invention will now be described more fully hereinafter, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. The device may be otherwise oriented (rotated 90 degrees or at other orientations) and the spatially relative descriptors used herein interpreted accordingly.

Well-known functions or constructions may not be described in detail for brevity and/or clarity.

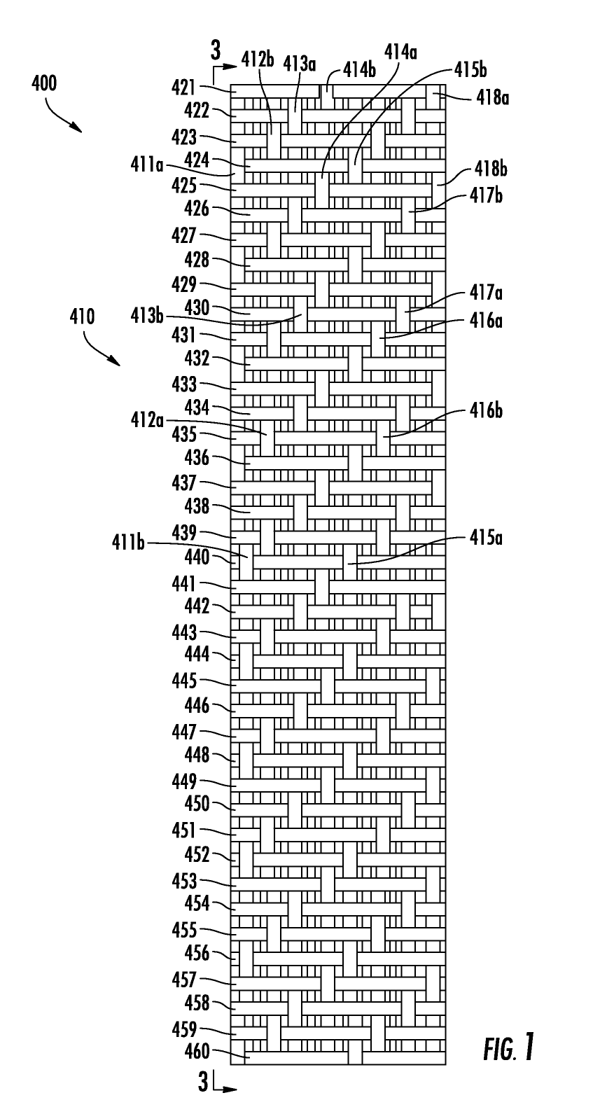

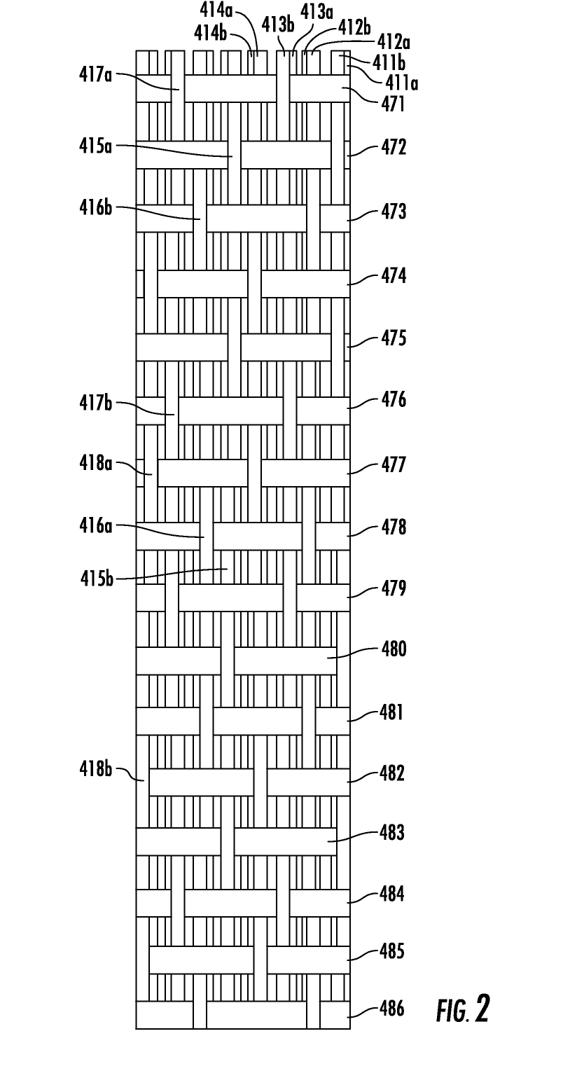

Referring now to the figures, FIGS. 1 and 2 are top and bottom views, respectively, of an exemplary woven triple layer papermaker's forming fabric 400. A repeat unit 410 of the fabric 400 includes eight pairs of MD stitching yarns 411a, 411b-418a, 418b, forty top CMD yarns 421-460, and sixteen bottom CMD yarns 471-486 (i.e., the ratio of top CMD yarns to bottom CMD yarns is 5:2). The interweaving of these yarns is described at some length in U.S. Pat. No. 8,196,613 to Ward, the disclosure of which is hereby incorporated herein by reference in its entirety. FIG. 3 illustrates the interweaving of two typical top MD yarns 411a, 411b with the top and bottom CMD yarns of the fabric 400.

Papermaker's fabrics have been manufactured via weaving for many years, first with wires serving as the material forming the fabric, then natural and synthetic fibers. However, weaving is a time-consuming process that can require very large looms that typically weave one weft yarn at a time; even with high speed looms, the manufacturing of a large papermaker's fabric can take considerable time. Also, the size of the loom can be a limitation on the size of the fabric it can produce. Further, looms are typically classified by the number of “harnesses” it has, which dictates the weave patterns that are available for fabrics made on such a loom; thus, some weave patterns may not be woven on certain looms. As such, it may be desirable to seek alternative techniques for manufacturing substrates that are configured like woven fabrics but that provide more flexibility to the manufacturing process.

As used herein, the term “papermaker's fabric” is intended to encompass not only woven fabrics of the variety illustrated in FIGS. 1-3, but also other substrates that mimic or resemble woven and/or non-woven fabrics. Woven structures can provide low contact area, excellent fiber support, high void volume and controlled drainage paths, which can be important for good drainage and minimal marking propensity.

One alternative technique for making a papermaker's fabric without weaving is three-dimensional “printing,” also known as “additive manufacturing.” With this technique, the three-dimensional structure of a substrate is digitized via computer-aided solid modeling or the like. The coordinates defining the substrate are then transferred to a device that uses the digitized data to build the substrate. Typically, a processor subdivides the substrate into thin slices or layers. Based on these subdivisions, the printer or other application device then applies thin layers of material sequentially to build the three-dimensional configuration of the substrate. Some methods melt or soften material to produce the layers, while others cure liquid materials using different methods.

One such technique is multi-jet modeling (MJM). With this technique, multiple printer heads apply layers of structural material to form the substrate. Often, layers of a support material are also applied in areas where no material is present to serve as a support structure. The structural material is cured, then the support material is removed. As an example, the structural material may comprise a curable polymeric resin, and the support material may comprise a paraffin wax that can be easily melted and removed.

Another such technique is fused deposition modeling (FDM). This technique also works on an “additive” principle by laying down material in layers. A plastic filament or metal wire is unwound from a coil and supplies material to an extrusion nozzle which can turn the flow on and off. The nozzle is heated to melt the material and can be moved in both horizontal and vertical directions by a numerically controlled mechanism, directly controlled by a computer-aided manufacturing (CAM) software package. The model or part is produced by extruding small beads of thermoplastic material, such as ABS, polycarbonate, and the like, to form layers; typically, the material hardens immediately after extrusion from the nozzle, such that no support structure is employed.

Still another class of alternative technique involves the use of a selective laser, which can either be selective laser sintering (SLS) or selective laser melting (SLM). Like other methods of 3D printing, an object formed with an SLS/SLM machine starts as a computer-aided design (CAD) file. CAD files are converted to a data format (e.g., an .stl format), which can be understood by a 3D printing apparatus. A powder material, most commonly a polymeric material such as nylon, is dispersed in a thin layer on top of the build platform inside an SLS machine. A laser directed by the CAD data pulses down on the platform, tracing a cross-section of the object onto the powder. The laser heats the powder either to just below its boiling point (sintering) or above its melting point (melting), which fuses the particles in the powder together into a solid form. Once the initial layer is formed, the platform of the SLS machine drops—usually by less than 0.1 mm—exposing a new layer of powder for the laser to trace and fuse together. This process continues again and again until the entire object has been formed. When the object is fully formed, it is left to cool in the machine before being removed.

Still other techniques of additive manufacturing processes include stereolithography (which employs light-curable material and a precise light source) and laminated object manufacturing.

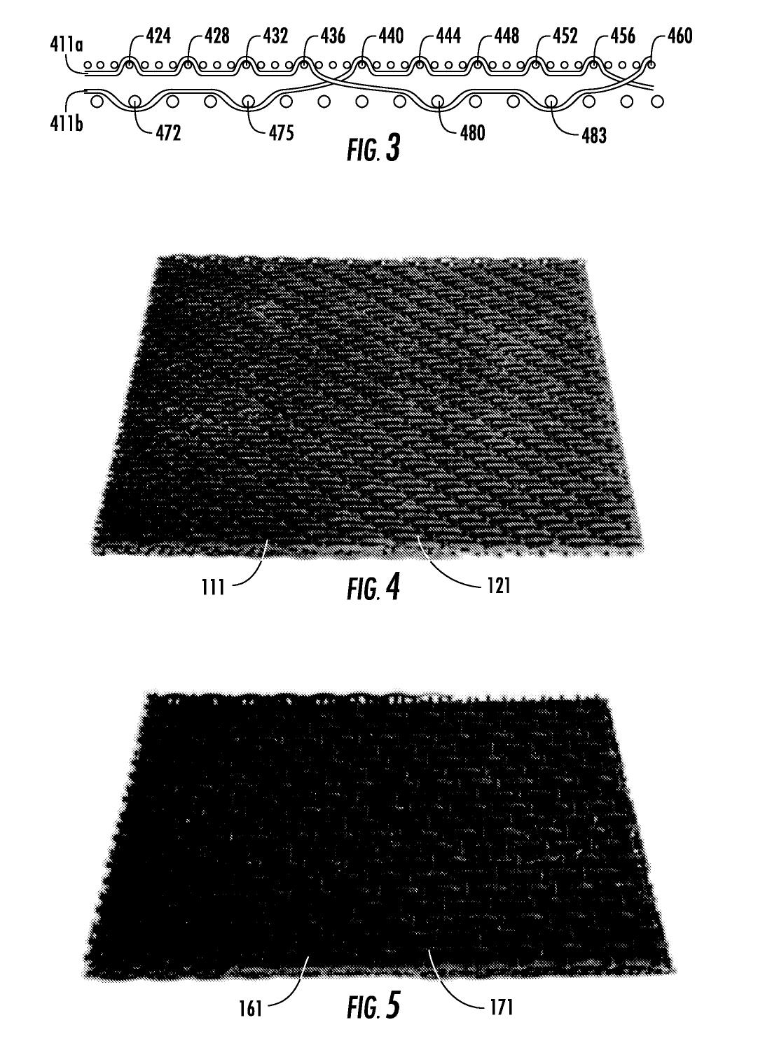

As can be seen in FIGS. 4-6, an additive manufacturing process can be employed to make a substrate that closely resembles the woven papermaker's fabric shown in FIGS. 1-3. FIG. 4 is a top view of a portion of the substrate/fabric, with portions 111 and 121 serving in place of the top MD yarns and CMD yarns, respectively. FIG. 5 is a bottom view of a portion of the substrate/fabric, with portions 161 and 171 serving in place of the bottom MD yarns and CMD yarns, respectively. FIG. 6 is a section view of the substrate/fabric of FIGS. 4 and 5 taken in the machine direction that shows that the substrate/fabric includes voids that correspond to the voids of a woven fabric. As such, it can be seen that an additive manufacturing process, such as a MJM process, can create a substrate that is configured like a woven fabric and that can, therefore, be used in lieu of a woven fabric in a papermaking process.

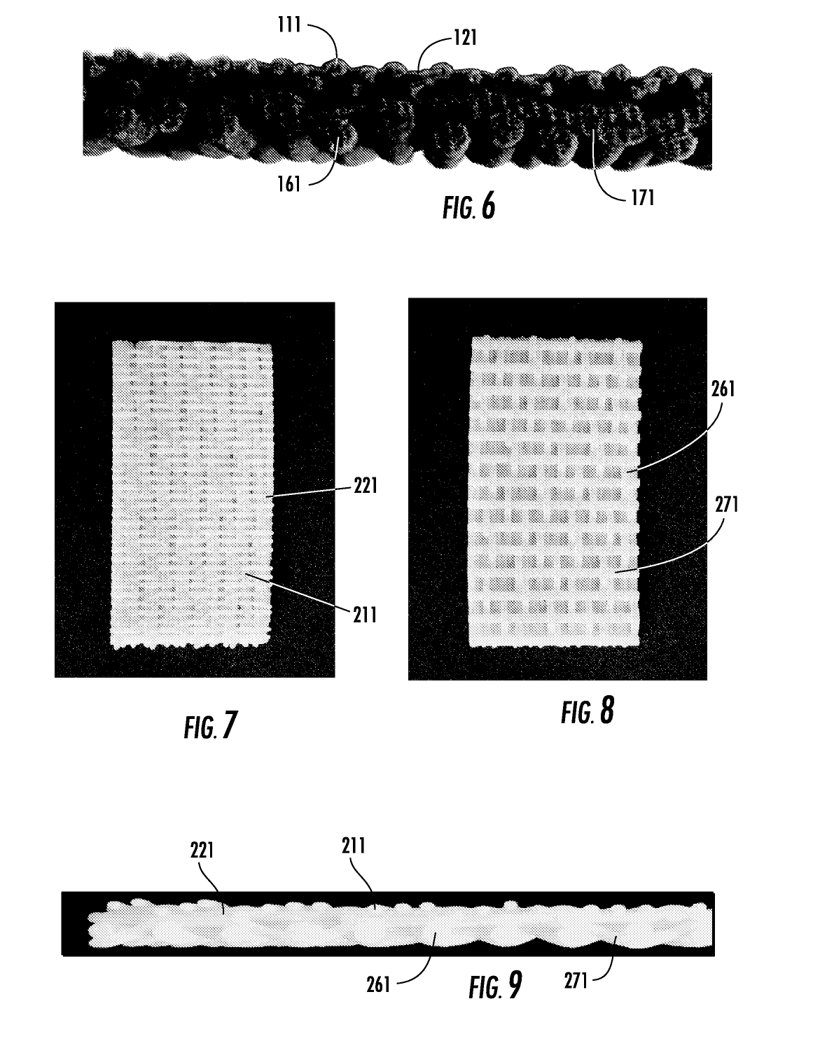

FIGS. 7-9 are top, bottom and section views of another substrate formed to mimic the papermaker's forming fabric illustrated in FIGS. 1-3. As shown in FIGS. 7 and 9, portions 211 and 221 serve in place of top MD yarns and CMD yarns, respectively, and, as shown in FIGS. 8 and 9, portions 261 and 271 serve in place of bottom MD yarns and CMD yarns, respectively.

It should be noted that a three-dimensional forming process of this type may also be performed on an existing fabric to enhance the fabric. For example, a support surface created by three-dimensional techniques may be applied to a coarser woven base fabric to form the papermaking surface; such a support surface may be a fine plain weave or a random arrangement, depending on the fabric's performance requirements. In either instance, such a support surface may enhance the fiber support printed onto the paper-side of a forming fabric. In another example, the machine side surface of a fabric may be enhanced by printing machine direction “yarns” to reduce drag and/or to increase mass to improve life potential of the fabric without increasing caliper.

Moreover, papermaking structures that replace woven fabrics may also be created that do not precisely “mimic” woven fabrics. For example, a typical woven papermaking forming fabric has a relatively uniform series of yarns and voids across its length and width. In some instances, it may be desirable to vary the width of the yarns and/or the voids in the cross-machine direction to provide very high yet random fiber support to reduce or minimize marking propensity. In addition, in a woven fabric the shapes of the voids are determined based on the shape of the yarns woven into the fabric. In some embodiments, it may be desirable to modify the shapes of the drainage holes and other voids by using “yarn” shapes that may be difficult to manufacture or weave, but which may be achievable via three-dimensional modeling and subsequent printing. As an example, a trapezoidal cross-section for a “yarn” may provide desirable support/drainage, but is difficult, if not impossible, to weave such that the yarn is consistently oriented correctly without twisting; with a three-dimensional printing process, the “yarn” could be oriented correctly throughout the fabric. In some embodiments, a three-dimensional printing process may be used to form a substrate/fabric comprising engineered voids or drainage channels as described in U.S. Pat. No. 8,251,103, the disclosure of which is hereby incorporated herein by reference in its entirety. As still another example, most triple layer forming fabrics include “stitching yarns” that bind the top and bottom layers together. The presence of stitching yarns can impact the papermaking properties of the fabric, so their number, placement, weave sequence, etc. must be considered in the design of a fabric. A three-dimensional printing process may enable the top and bottom layers to be joined together with a structure that does not resemble a stitching yarn, which may provide the designer with greater flexibility in designing the fabric and/or may provide enhanced drainage and support properties. As an additional example, the fabric could mimic a non-woven fabric. In some embodiments, such a fabric may have non-uniform hole sizes on the support surface with an open area of at least 15%, an internal void volume of 40-70% and/or a higher mass distribution on the machine-side surface in order to provide mechanical stability and wear resistance.

Materials employed in fabrics according to embodiments of the invention may be any that are known to be suitable for the processes discussed above. Exemplary materials include digital alloys, such as polyurethanes and/or acrylics, that may provide strength, flexibility, chemical resistance, and/or abrasion resistance.

In some embodiments, the fabric is formed in a production process in which the fabric is manufactured in a flat form and subsequently joined. In other embodiments, the fabric is manufactured in the form of an endless belt to avoid seaming, bonding or welding. The fabric may be up to 100 meters or more in length and up to 10 meters or more in width. For example, the fabric may be about 10, 20, 30, 40, 50, 60, 70, 80, 90, 100, 110, 120, 130, 140, 150 meters or more in length and about 1, 2, 3, 4, 5, 6, 7, 8, 9, 10, 11, 12, 13, 14, 15, 16, 17, 18, 19, 20 meters or more in width.

Those skilled in this art will recognize that, although papermaking forming fabrics are illustrated and described herein, fabrics employed as the base fabrics for press felts and dryer fabrics used in papermaking and layers and portions thereof may also be suitable candidates for processes and techniques discussed herein. It should also be noted that, although a triple layer forming fabric is discussed above, other forming fabrics, such as single layer, double layer, and the like, may also be formed with the processes and techniques of the present invention.

Also, in some embodiments, the fabric may be formed in a smaller size and employed for testing purposes. Often, producers of papermaker's fabrics will weave small prototype fabrics on a pilot loom for evaluation of their properties. Using an additive manufacturing technique such as those discussed above may enable prototype fabric samples to be produced quickly and easily.

Those of skill in this art will also appreciate that other types of woven and non-woven industrial textiles, particularly those employed in filtration-type processes, may also be formed with the techniques described above. For example, fabrics employed in such applications as industrial filtration, dry-laid web formation and fiber cement production may benefit from the design flexibility afforded by 3D printing. Other examples may be apparent to those of skill in this art.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of manufacturing a fabric, comprising the steps of:
developing a three-dimensional model of a fabric; and
utilizing the three-dimensional model in an additive manufacturing process to build a fabric.

2. The method defined in claim 1, wherein the utilizing step comprises a multi-jet printing process.

3. The method defined in claim 1, wherein the fabric is based on a woven fabric structure.

4. The method defined in claim 1, wherein the fabric is based on a non-woven structure.

5. The method defined in claim 4, wherein the non-woven structure has at least one of: non-uniform hole sizes on the support surface with an open area of at least 15%; an internal void volume of 40-70%; and a higher mass distribution on the machine-side surface to provide mechanical stability and wear resistance.

6. The method defined in claim 1, wherein the fabric is produced in an endless loop without seaming, bonding or welding.

7. The method defined in claim 1, wherein the fabric comprises a digital alloy material.

8. The method defined in claim 1, wherein the fabric comprises a papermaker's fabric.

9. The method defined in claim 1, wherein the fabric comprises an industrial textile.

10. A method of providing an enhanced support surface on an existing fabric, comprising the steps of:
developing a three-dimensional model of a support surface; and
utilizing the three-dimensional model in an additive manufacturing process to build a support surface on the existing fabric.

11. The method defined in claim 10, wherein the utilizing step comprises a multi-jet printing process.

12. The method defined in claim 10, wherein the enhanced support surface is based on a fine woven fabric structure.

13. The method defined in claim 10, wherein the enhanced support surface is a random distribution of support fibers or strands.

14. The method defined in claim 10, wherein the fabric comprises a digital alloy material.

15. The method defined in claim 10, wherein the existing fabric is a papermaker's fabric.

16. The method defined in claim 15, wherein the existing fabric is an endless coarse single layer base fabric.

17. A method of providing an reduced drag wear surface on an existing fabric, comprising the steps of:
developing a three-dimensional model of a wear surface; and
utilizing the three-dimensional model in an additive manufacturing process to build a wear surface on an endless fabric.

18. The method defined in claim 17, wherein the fabric comprises a digital alloy material.

19. The method defined in claim 17, wherein the existing fabric is a papermaker's fabric.
